(19) United States
(12) Patent Application Publication
(10) Pub. No.: US 2019/0301424 A1
(43) Pub. Date: Oct. 3, 2019

(54) APPARATUS FOR GENERATING ENERGY FROM FLOWING WATER

(71) Applicant: EQA Projects B.V., Werkendam (NL)

(72) Inventors: Jan Jacobus VAN BOXEL, Werkendam (NL); Pieter Marinus VERSLUIS, Werkendam (NL)

(21) Appl. No.: 16/302,867

(22) PCT Filed: May 18, 2017
(86) PCT No.: PCT/NL2017/050313

§ 371 Date: Nov. 19, 2018

(30) Foreign Application Priority Data
May 19, 2016 (NL) 2016796
Nov. 28, 2016 (NL) 2017879
May 4, 2017 (NL) 2018844

(51) Int. Cl. F03B 7/00; H02K 7/18; H02K 11/35; F03B 17/06

(52) U.S. Cl. CPC F03B 7/00; H02K 7/1823; H02K 11/35; F05B 2240/20; F05B 2210/11; F05B 2220/7068; F03B 17/062

(57) ABSTRACT

Apparatus for generating energy from flowing water, which comprises a paddle wheel rotatable around a horizontally disposed shaft, with a plurality of paddles arranged along an outer circumference of the paddle wheel. The apparatus further comprises channeling means for channeling a water stream in a range of the paddle wheel that is located under the horizontally disposed shaft, and a generator for generating electric energy, driven by the paddle wheel. Automatically, setting means optimally set a position taken up by the paddle wheel relative to a water surface of the water stream. With this apparatus, an interaction taking place between the water stream and individual paddles of the paddle wheel is optimized.

This invention relates to an apparatus for generating energy from flowing water, in particular to a hydroelectric installation of comparatively modest size.

Hydropower plants are for instance known for the drive of machinery in the form of watermills and for generating electric energy with the aid of artificially constructed reservoirs. This latter form is geographically limited in placement and moreover depends on the local conditions, which must allow of the necessary drastic infrastructural adaptations.

Increasingly, for the growing electric energy needs, and on environmental grounds, reliance is made on locally placed relatively small-scale energy-generating devices, such as windmills and solar panels. To connect these energy-generating devices with the existing electricity grid, often new infrastructure, such as power cables, needs to be provided because it is not present yet. In a water-abundant landscape with polders and rivers, however, such infrastructure is often present and is used for operating and monitoring polder weirs, or for beaconing river groynes. To date, this infrastructure has not been utilized yet for electric energy feedback to the grid.

Accordingly, it is an object of the present invention to eliminate at least one of the disadvantages of the prior art, or to alleviate the consequences thereof. It is also an object of the present invention to provide ameliorated or alternative solutions that can be implemented in a simpler manner and moreover can be made comparatively inexpensively. Alternatively, it is an object of the invention to provide to the public an at least useful option.

To this end, the invention provides an apparatus for generating energy from flowing water, as defined in one or more of the appended claims. More particularly, the apparatus according to the invention comprises a paddle wheel rotatable around a horizontally disposed shaft, with a plurality of paddles arranged along an outer circumference of the paddle wheel, channeling means for channeling a water stream in a range of the paddle wheel that is located under the horizontally disposed shaft, a generator for electric energy, driven by the paddle wheel, and setting means for automatically setting a position taken up by the waterwheel relative to a water surface of the water stream. With the apparatus, an interaction taking place between the water stream and individual paddles of the plurality of paddles arranged along the outer circumference of the paddle wheel is optimized. The automatic setting of an optimum position taken up by the paddle wheel relative to a water surface is especially important with locally placed, comparatively small-scale energy-generating devices which would otherwise be difficult to observe and monitor.

The generator driven by the paddle wheel is preferably a permanent magnet generator. In some cases, the generator to be driven by the paddle wheel can have a shaft drive with a right-angle transmission, and in other cases a toothed-belt drive. In the latter case, a low-speed permanent magnet generator is preferred.

In an implementation variant of the invention, the setting means may be expanded to include an intelligent data system.

In an apparatus according to the invention, the paddle wheel may have a core drum, whose centerline coincides with the horizontal shaft. Further, the core drum may then be provided at each of its opposite axial ends with a side or end flange, extending radially from an outer circumference of the core drum.

The paddle wheel rotatable around the horizontal shaft may, in the invention, also comprise a plurality of individually movable paddles. These individual paddles may then each be movable between a passive tangential position, in which it can pass in a water stream with minimal resistance, and an active radial position, in which it can be optimally driven by a water stream. Preferably, each individually movable paddle is pivotable about a paddle pivot extending parallel to the horizontal shaft and can then be pivotable about a paddle pivot situated at the outer circumference of the core drum. Optionally, each paddle pivot extending parallel to the horizontal shaft can comprise a pivot arranged between two opposite end flanges of a core drum.

The movement of each paddle from its passive tangential position to its active radial position may be limited by a projecting stop, in which case each individually movable paddle in its active position can abut by an outwardly facing side thereof against the stop. The stops may be positioned in circumferential direction of the paddle wheel between two successive pivots and may also serve as stops for the passive position in that an inwardly facing side of each paddle comes to a stop against a stop trailing in circumferential direction. If desired, it is also possible to have the movable paddles in their passive position abut, overlapping by their inner side, against an outer side of a trailing adjacent paddle.

Each paddle may further comprise a convexly shaped outer side and a convexly shaped inner side. In the active position a respective paddle receives water in the concavely shaped inner side. This design in combination with the core drum not only increases efficiency but also contributes to the fish-friendliness of the paddle wheel.

In the apparatus according to the invention, the automatic setting means for optimally setting a position to be taken up by the paddle wheel can make use of parameters selected from a group comprising: water supply, water flow rate, water height, speed of the paddle wheel, position of the paddle wheel, energy requirement, electric tension, as well as signals of limit switches and charging current control devices. The automatic setting means may then be configured for, starting from measurements, by software, giving a command to set the waterwheel at a different height position relative to the water surface. The automatic setting means may then also comprise at least a communication module and/or a monitoring module, at least one of which is configured for, at a low electric tension, limiting the power consumption by partly switching off the automatic setting means. Further, the automatic setting means may comprise a monitoring module which is configured for, in a predetermined time interval, activating a PLC unit and a communication module of the automatic setting means to carry out measurements and to process obtained measuring data to optimize, or keep optimal, the position taken up by the paddle wheel relative to the water surface. The monitoring module may then be configured for continuously measuring a water level upstream of the paddle wheel, so that when a pre-set limit is exceeded within the predetermined time interval the PLC unit and the communication module are activated so as to be able to intervene if necessary. Optionally, further, also a camera registration may be part of the automatic setting means.

In a particular embodiment of the invention, the apparatus is part of a weir with a fall in height between an inlet water surface at an upstream side and an outlet water surface at a downstream side. This weir is arranged for water management of a polder, and the channeling means are then advantageously implemented as a movable water guide on the upstream side. The setting means for optimizing then preferably comprise at least a single carrying arm which carries the horizontally disposed shaft and which extends from a fixed pivoting point at the downstream side up to a height-adjustable slide at the upstream side. The at least single arm is then movable up and down about the fixed pivoting point, together with the horizontally disposed shaft, along with the height-adjustable slide, and the movable water guide with the carrying arm. For optimization of an interaction taking place between the water stream and individual paddles of the paddle wheel, it is important that the waterwheel and a water guide implemented as a fish/water slideway are fixedly connected with each other. By setting the position of the water jet on the paddles, a maximum energy yield can be obtained, and practical experiences with the hydropower can be optimized and utilized. The means with which a position taken up by the waterwheel relative to a water surface of a water stream is automatically set comprise a water level tube, which can deliver a signal for operation of a spindle slide motor. The water guide implemented as a fish/water slideway is connected with the height-adjustable slide implemented as a spindle slide. The spindle slide is driven by an electronic spindle slide motor. By setting a liquid height, the water level tube delivers a signal so that the spindle slide motor moves the slide up and down to the desired liquid height set. Starting from measurements, by means of software a command can be given to the spindle motor to set the waterwheel at a different height position relative to the water surface, by having the spindle or spindles turn clockwise or anticlockwise. Preferably, the height-adjustable slide can then set a fall in height between the inlet water surface and the outlet water surface of between 20 cm and 200 cm.

Such a polder weir may further comprise a technical space, which is arranged underground. The technical space then serves for accommodation of operating and monitoring means of the polder weir.

Also, measures may have been taken for protecting the water population. Such measures for protecting the water population can comprise a grid placed on the upstream side. The measures for protecting the water population can also comprise a fish-friendly water guide and a fish-friendly paddle shape for the individual paddles. A fish-friendly water guide and a fish-friendly paddle wheel are obtained in that in the polder weir the water guideway implemented as a fish/water slideway, as it were, lays each fish in a water tray formed by the paddle and lets it go down with its own water. Thus, the fish does not fall down and cannot become jammed by the paddle. Also, the paddle wheel mostly turns at a sufficiently low speed.

Alternatively, the apparatus according to the invention can also be part of a hydroelectric plant placed off the fairway in the surface water along the bank of a river. The channeling means are then formed by at least a single (buoyancy) float, and the setting means for optimizing then comprise at least a single ballast tank and a pump which is arranged in the at least single float and is in fluid communication with the surface water and that ballast tank. The hydroelectric plant is then anchored to a river groyne in a manner so as to be movable up and down. The part of the at least single float remote from the groyne may then be guided in a vertical direction along a pole anchored in the river bed, to which pole also a beacon for navigation may be mounted. The horizontally disposed shaft of the paddle wheel may be bearing-mounted to the at least single float.

The paddle wheel may also be arranged between the at least single float and a second float. This first and second float may then be connected with each other, so that also the second float can be part of the channeling means. The number of pumps that is needed or that is used per float of this river unit for filling or emptying two ballast tanks per float may in each case be at least a single pump per float and per ballast tank. In total, there are preferably two pumps and four ballast tanks. For each float, this is preferably a (liquid level control) float pump. Per float there are preferably two ballast tanks in order that in the event of collision damage or of leakage, there is less chance of sinking. Also, two ballast tanks per float can be set more accurately and are more stable in case of wash. The second float, as mentioned, may then also comprise at least a single ballast tank which is part of the setting means, but preferably also has two ballast tanks. In this river unit also, an automatic setting of a position taken up by the waterwheel or paddle wheel relative to the water surface can be obtained by automatic control of the pump. Starting from measurements and by means of software, here too, a command can be given to the ballast pump system to set the waterwheel at a different height position relative to the water surface by means of the floats.

A part of the circumference of the paddle wheel that is located above the horizontally disposed shaft may be covered with a protective hood.

At least upstream of the paddle wheel at the inlet side, a trash or dirt guide may be arranged. In the river unit, such dirt guide may also be arranged on the outlet side (downstream), because many rivers have ebb and flow and so have two flow directions. Upstream of the paddle wheel, additionally, a grid floor extending in a horizontal plane above the floats may be arranged.

An automatically height-adjustable waterwheel coupled to a water and fish slideway in combination with a polder weir is not known yet. Generating energy may further, in the polder weir according to the invention, be combined with the carrying out of measurements, as of precipitation, flow rate, soil hydrology, and electric tension present.

In both the polder weir variant and the river variant of the apparatus according to the invention, the waterwheel turns in the flow direction, around a horizontally disposed shaft. This is animal-friendliest. The (liquid level control) float system of the river variant arranges that if a floating obstacle is signaled, the wheel comes clear of the water by virtue of this system. In the river variant, the wheel with this float system, besides serving for energy production, can also serve to retain water in a river or to discharge additional water if desired, the settability of this measure may be automated. Like the polder weir variant, also the river variant can be sustainably utilized for flexible water level management. Measurements that can be used for the automatic height adjustment can comprise parameters such as: water supply (liquid flow), water height, speed of the waterwheel, energy requirement, and/or electric tension.

It is also important that principal components of the apparatus, such as paddle wheel and water guides, can be made from recycled plastic.

The common advantages can be summarized as follows:
Low speed, long life and animal-friendly.
In a rotary direction along with the water flow, particularly animal-friendly.
An automatically height-adjustable waterwheel, optimum energy efficiency and automatically settable.
An automatically height-adjustable waterwheel, which can also be lifted completely out of the water in the case of obstacles and/or a large water afflux that must not be impeded.
Nearly the whole plant can be made from recyclable high-grade plastic.
An ecological paddle shape can be used.

Other advantageous aspects of the invention will be elucidated on the basis of the following detailed description with reference to the appended drawings, in which:

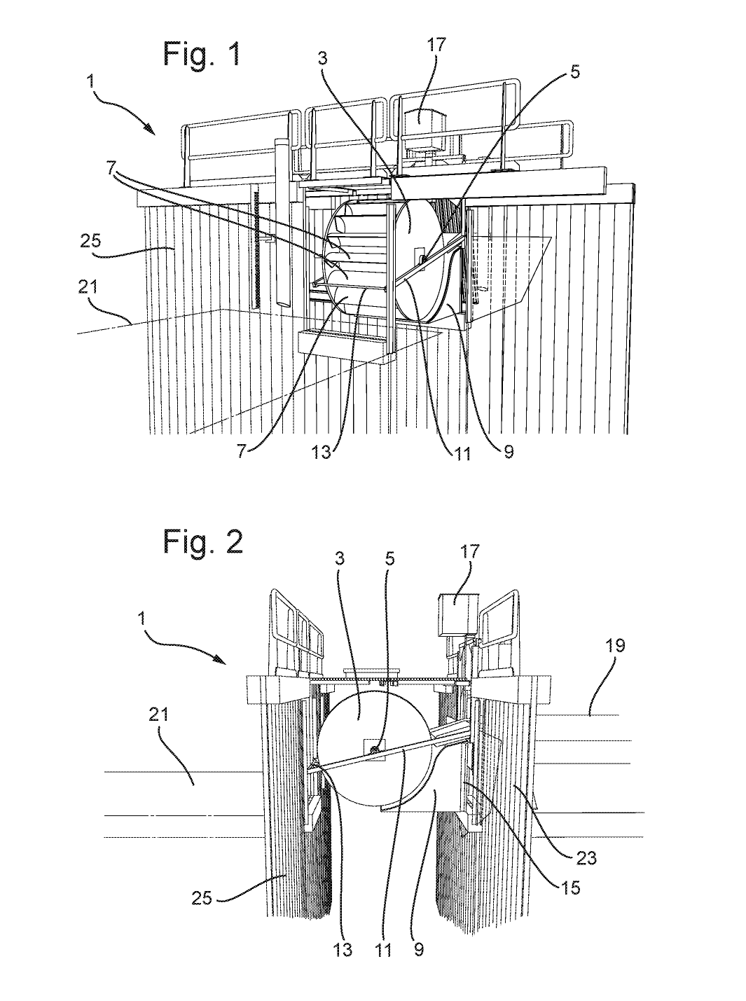

FIG. 1 is a view in perspective of a polder weir according to the invention seen from the downstream side;

FIG. 2 is a side view of the polder weir of FIG. 1;

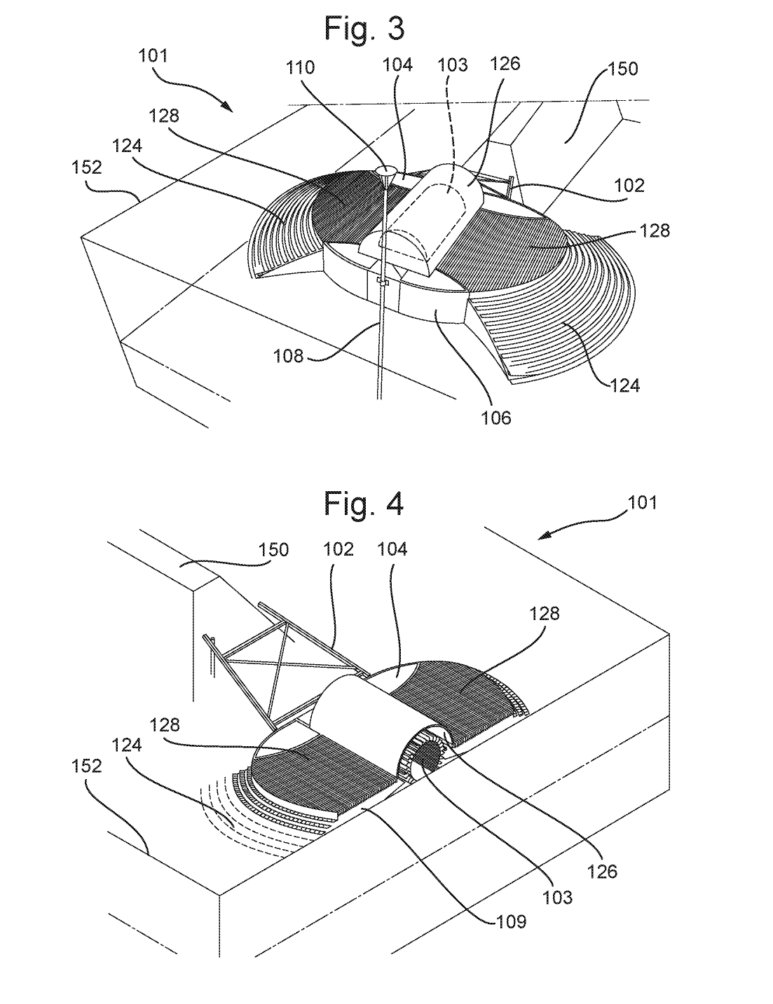

FIG. 3 is a top plan view in perspective of a river unit according to the invention;

FIG. 4 is a top plan view in perspective of the river unit according to FIG. 3 seen from the downstream side and partly in cross section;

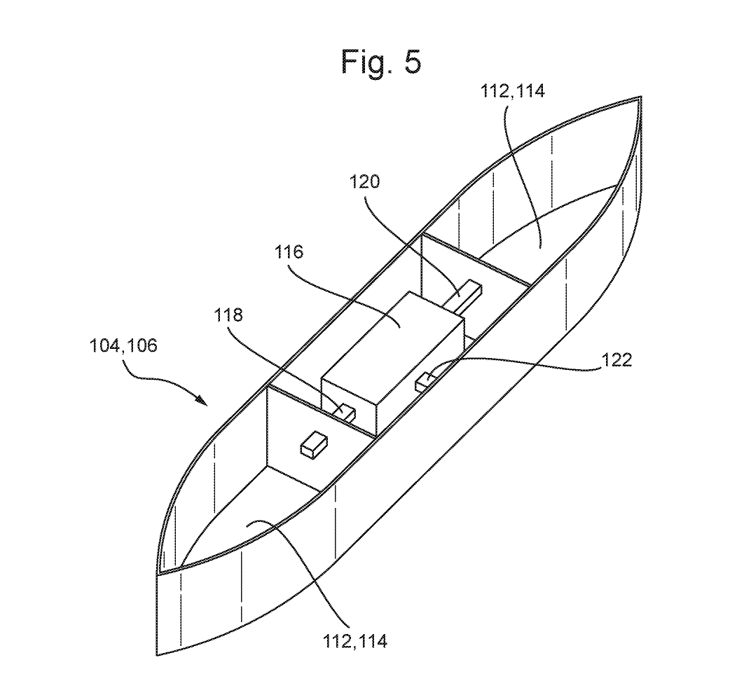

FIG. 5 is a view in perspective of a float for the river unit of FIGS. 3 and 4, whose top has been left open to show the interior;

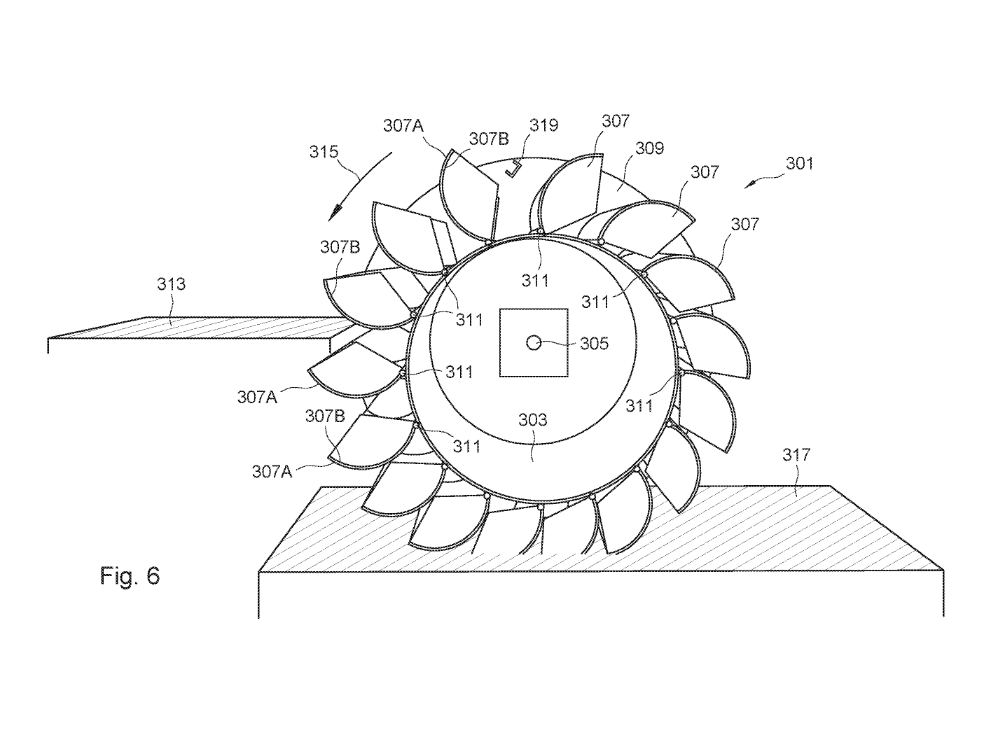

FIG. 6 shows partly in cross section a variant of a paddle wheel for drive by a water stream;

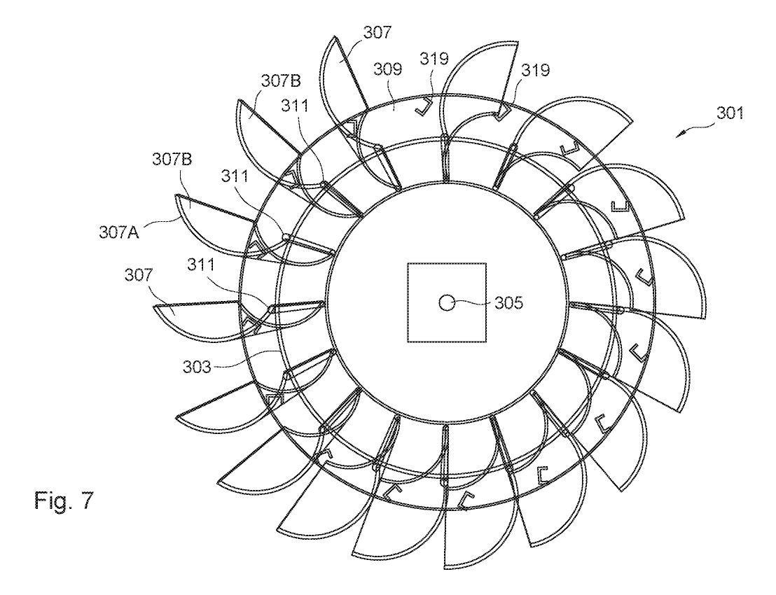

FIG. 7 is a cross section of the paddle wheel of FIG. 6;

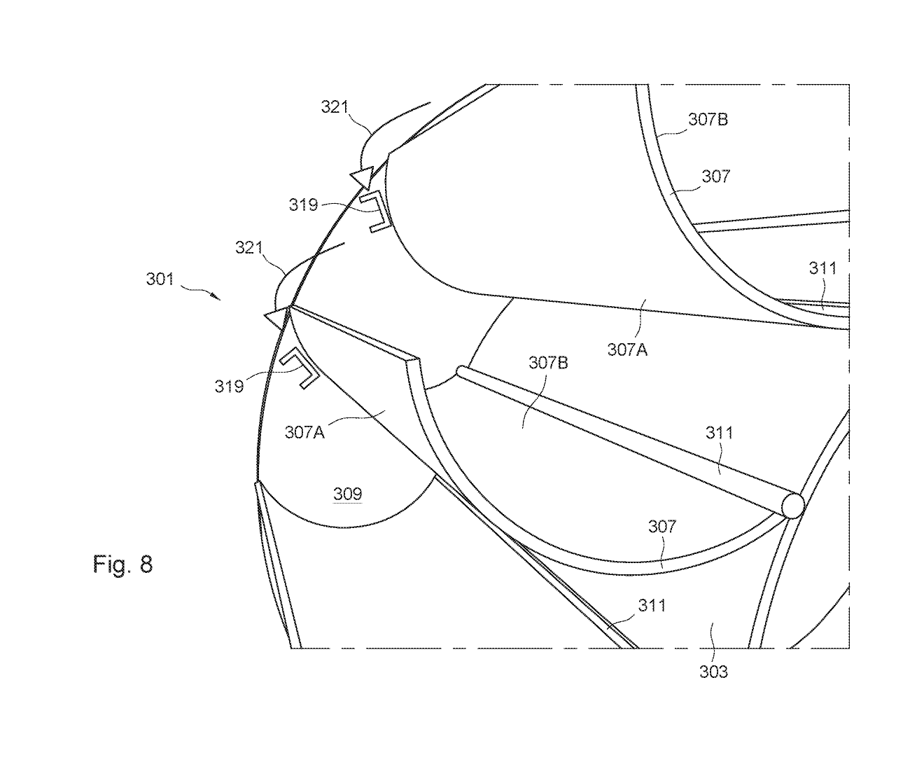

FIG. 8 is a detailed view of an end of the paddle wheel of FIG. 6; and

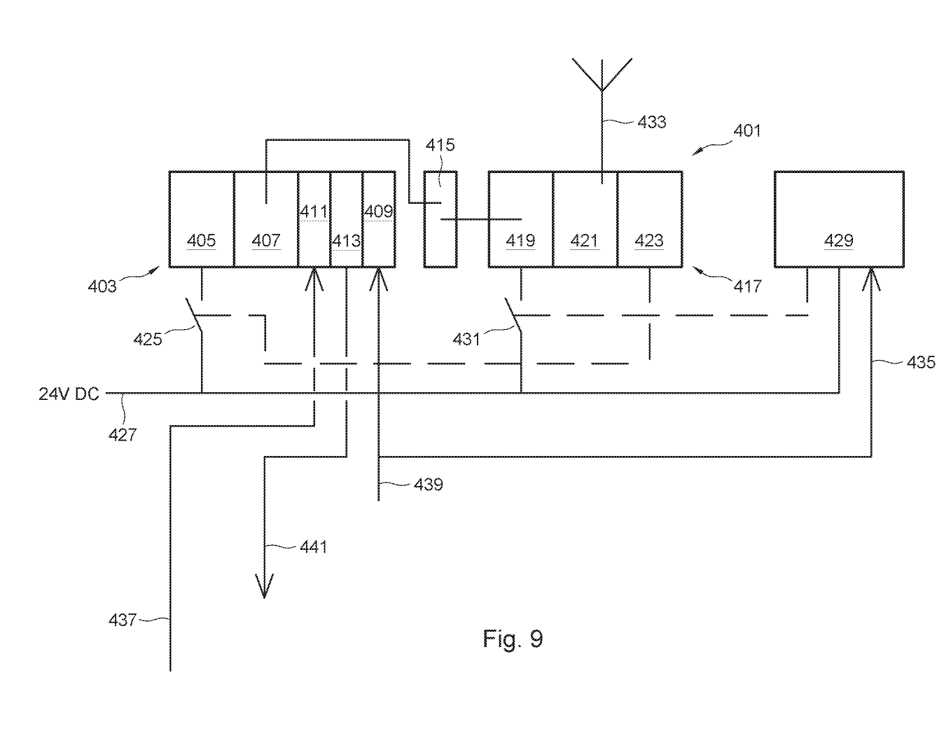

FIG. 9 is a diagram for an intelligent PLC system for automatically setting an optimal position taken up by the paddle wheel relative to a water surface.

Seen from the downstream side, in FIG. 1 a polder weir hydroelectric plant 1 is shown, which comprises an apparatus for generating energy from flowing water. The apparatus comprises a waterwheel or paddle wheel 3, which is set up rotatably for rotation around a horizontally extending shaft 5. Arranged along the circumference of the paddle wheel 3, at regular distances from each other, are a number of paddles 7. A channeling means for channeling a water stream along the circumference of the paddle wheel 3 is here implemented as a movable water guide 9. The horizontal shaft 5 is bearing-mounted on a carrying arm 11 which on the downstream side is pivotable about a pivot 13. At the back of the paddle wheel 3 (not visible in FIGS. 1 and 2) is a carrying arm identical to the carrying arm 11, which is also pivotable about the pivot 13. Also the non-visible opposite end of the horizontal shaft 5 is likewise bearing-mounted to this identical carrying arm. The water guide 9 and the end of the carrying arm 11 at the upstream side are mounted to a height-adjustable slide 15, as shown in FIG. 2. This height-adjustable slide is driven by a spindle motor 17 so as to be adjustable in height, and as the slide 15 moves up and down, the carrying arm 11 and the water guide 9 move up and down concurrently with the slide. The carrying arm 11 then pivots about the pivot 13 and thereby moves the horizontal shaft 5 with the paddle wheel 3 up and down, simultaneously with the water guide 9. A distance of the water guide 9 and the paddles 7 that is correct under all circumstances is thus ensured. It will be understood that this distance, if so desired, can also be implemented so as to be pre-settable.

The water guide 9 preferably extends to over the slide 15. As can be properly seen in FIG. 2, an inlet water surface 19 at the upstream side of the polder weir hydroelectric plant 1 is higher than a water surface 21 at the outlet side. A fall in height between the inlet water surface 19 and the outlet water surface 21 can be set by the height-adjustable slide 15. Such adjusting in height of the slide 15 can be done automatically and be controlled remotely. The setting means necessary for this can comprise a water level tube (not shown but conventional) which delivers a signal for operation of the spindle motor 17. In a practical embodiment, the slide 15 of the polder weir 1 may be designed to be adjustable in height over a distance of approximately 2 m. To the side of, or between, bounding walls 23, 25 of the polder weir hydroelectric plant 1 at the inlet side and the outlet side, an underground technical space may be provided for arranging appendages, such as a generator to be driven by the paddle wheel 3 and/or operating and monitoring means of the polder weir. The drive by the paddle wheel 3 of the generator (not shown, but conventional) may be implemented as a right-angle transmission or a toothed-belt drive, conventional in themselves.

Measures for protecting the water population may have been provided by having a fish-friendly water guide put together with a fish-friendly paddle shape. As an additional measure, further, a grid may be placed on the upstream side (not visible in the Figures, but conventional).

An alternative embodiment of the invention is shown in FIGS. 3 through 5. This concerns a river hydroelectric plant 101 preferably placed off the fairway along the bank of a river. Preferably, this river hydroelectric plant 101 is anchored to a river groyne 150 in a manner so as to be movable up and down. This anchoring is implemented as a swiveling frame 102, which is hinged both to the groyne 150 and to an inner float 104 of the river hydroelectric plant 101. As a result, the hydroelectric plant 101 can maintain its position relative to the water surface 152 at high and low tide in the river. A paddle wheel 103 is set up rotatably for rotation around a horizontal shaft, which is bearing-mounted between the inner float 104 and an outer float 106. The inner and outer floats 104, 106 then serve also as channeling means for channeling a water stream under the horizontal shaft and within the range of the paddle wheel 103. A generator (not shown, but conventional) driven by the paddle wheel 103 may be accommodated in one of the inner or outer floats 104, 106. Also, there may be a generator for generating electric energy in each float. The outer float 106 is guided in its vertical movement relative to the river groyne 150 along a pole 108 anchored in the river bed, to which a beacon 110 for navigation is mounted.

Setting means for optimizing the position taken up by the paddle wheel 103 relative to the water surface 152 are implemented as ballast tanks 112, 114 in the floats 104, 106, as shown in FIG. 5. A pump 116 is then in fluid communication with the ballast tanks 112, 114 by means of connecting conduits 118, 120 and with the surface water by means of an access conduit 122. The automatic setting of a position taken up by the waterwheel or paddle wheel 103 relative to the water surface 152 of the water stream can then be achieved by automatic control of the pump 116. The float 104, 106 as shown in FIG. 5 has an open top, but is preferably closed, as can be seen in FIGS. 3 and 4.

The channeling means may further also comprise a water guiding plate 109, as can be seen in FIG. 4. This water guiding plate 109 may further, together with paddles of the paddle wheel 103, be made of fish-friendly design again. Upstream, but in the case of river stretches subject to ebb and flow also downstream, of the paddle wheel 103, a trash or dirt guide 124 is arranged. Such dirt guide can also serve to connect the inner and the outer floats 104, 106 with each other.

An upper part of the circumference of the paddle wheel 103 is covered with a protective hood 126, which may be made of transparent material. Located between this protective hood 126 and the dirt guides 124 are grid floors 128 which extend in a horizontal plane above the floats 104, 106. These grid floors 128 also may be used to connect the inner and outer floats 104, 106 with each other.

The paddle wheel of FIGS. 6 through 8, designated with reference numeral 301, is suitable for application both as the paddle wheel 3 in the implementation variant according to FIGS. 1 and 2 and as the paddle wheel 103 in the implementation variant according to FIGS. 3 through 5.

The paddle wheel 301 has a core drum 303 which is rotatable around its own centerline, which coincides with a horizontally extending rotary shaft 305.

Around the outer circumferential surface of the core drum 303, a plurality of movable paddles 307 are arranged. These paddles 307 are movably mounted between end flanges 309, which bound the core drum 303 at each axial end.

In FIGS. 6 through 8, in each case only a single one of these lateral end or side flanges 309 is visible because the paddle wheel 301 is drawn in cross section. The movable paddles 307 are each mounted between the two end flanges 309 with a pivot 311. By means of the pivot 311, each paddle 307 can rotate between an active, substantially radial position, as shown for the left-hand half in FIGS. 6 and 7, and a passive, substantially tangential position, as shown in the right-hand half of FIGS. 6 and 7. Each paddle 307 further has a convexly shaped outer side 307A and a concavely shaped inner side 307B. In the active position, a respective paddle 307 receives water from the water level 313 in the concavely shaped inner side 307B. As a result, the paddle wheel 301 is set into rotation in the direction of arrow 315. Via the paddles 307 on the left-hand side in FIG. 6, water is transported from the water level 313 to the lower-lying water level 317. The pivots 311 extend parallel to the centerline of the core drum 303 and hence are also parallel to the central horizontal shaft 305. The active position of each of the paddles 307 is defined in that the convexly shaped outer side 307A butts against a projecting stop 319, only one of which is visible in FIG. 6. FIGS. 7 and 8 show these stops 319 more clearly. In FIG. 8 it is clearly seen how the paddles 307 in the direction of the arrows 321 come to a stop by their convex outer side 307A against the stop 319. The passive position of the paddles 307 may be limited in that the concave inner side 307B butts against a stop 319 of an adjacent paddle trailing in the direction of rotation, as can be seen in FIG. 7. Also, it is possible to have the paddles 307 in their passive position come to a stop by their concave inner side 307B against a convex outer side 307A of a paddle 307 trailing in the direction of rotation. As shown in FIG. 6, the paddle wheel 301 is here applied as an undershot waterwheel. It will be clear to those skilled in the art that if the direction of rotation and the difference in water level are adapted to that end, the paddle wheel 301 can also function as an overshot waterwheel. Also, when only the water level 317 is at hand, the paddle wheel 301 can also be driven in the same direction if the water level 317 is subject to a flow from left to right in FIG. 6. In that case, an application variant such as that according to FIGS. 3 through 5 is involved.

FIG. 9 shows a PLC system 401 for automatic height-setting of an optimal position of the paddle wheel relative to the water surface for both the above-described polder weir variant and the river variant. Measurements and control are done with the aid of a PLC unit 403, such as an Omron CJ2M PLC. This is a modular PLC, equipped with a supply 405, a CPU 407, an analog input module 409 (of 8×4.20 mA), a digital input module 411 and a relay output module 413. The CPU is provided with an Ethernet port 415 with which data can be transferred to a communication module 417. This communication module 417 is, for example, a modular router, such as eWon Flexy 202. Further, via the communication module 417 the PLC 403 can be programmed remotely (via a secure VPN connection). To limit power consumption at low battery voltage, the communication module 417 can switch the PLC 403 off. The communication module 417 includes a modular router 419, a GSM extension 421 and an I/O extension 423. The I/O extension is configured to operate a switch 425, allowing a current source 427 to be connected, or not, with the supply 405 of the PLC unit 403.

Further included in the system is a monitoring module 429 which at low battery voltage can also switch off the communication module 417 by operation of a switch 431. The circuit in the monitoring module 429 switches on the communication module 417, and indirectly the PLC unit 403, every six hours so that a measurement can be done and the measuring data can be transmitted to a server via antenna 433. In addition, the monitoring module 429 measures the upstream water level via a sensor input 435. Should this water level within the period of six hours rise quickly (settable limit), the communication module 417 and the PLC unit 403 are switched on immediately to take any necessary action.

A signal connection 437 is connected from a charging current controller and limit switches to an input of the digital input module 411. A signal connection 439 is present for forwarding parameters such as: water levels, paddle wheel position, generator voltage, battery voltage, water flow rate, energy requirement, paddle wheel speed and camera registration. The signal connection 439 is connected to an input of the analog input module 409 and branches off to the sensor input 435 of the monitoring module 429. A control signal line 441 is connected to an output of the relay output module 413 of the PLC unit 403 for controlling the spindle motor 17 or ballast pump 116, depending on the implementation variant of the apparatus.

The function of the communication module 417 in the system 401 is twofold: the PLC system 401 collects measuring data from the PLC and makes them available via a built-in webserver. The webserver can be accessed via the Internet by means of an encrypted VPN connection. This VPN connection can also be used to pick up the data stream of a camera (optional) but also, for example, to (re)program the PLC remotely.

Thus, an apparatus (1, 101) has been described that is suitable for generating energy from flowing water and which comprises a paddle wheel (3, 103) rotatable around a horizontally disposed shaft (5), with a plurality of paddles (7) arranged along an outer circumference of the paddle wheel. The described apparatus (1, 101) further comprises channeling means for channeling a water stream in a range of the paddle wheel that is located under the horizontally disposed shaft (5), and a generator for generating electric energy, driven by the paddle wheel (3, 103). Automatically, setting means optimally set a position taken up by the paddle wheel (3, 103) relative to a water surface of the water stream. With this apparatus, an interaction taking place between the water stream and individual paddles (7) of the paddle wheel (3, 103) is optimized.

It is believed that the construction and the operation of the invention are readily apparent from the foregoing description. The invention is not limited to any embodiment described herein. For the sake of clarity and conciseness of the description, herein features have been described as part of the same or of separate embodiments, but it will be clear to those skilled in the art that the scope of protection of the invention also encompasses embodiments that comprise combinations of some or all of the features described. Within the purview of one skilled in the art, alterations are possible which are understood to be within the scope of protection. Also, all kinematic inversions are understood to be within the scope of protection of the present invention. Expressions such as “consisting of”, when used in this description or the appended claims, should be construed not as an exhaustive enumeration but rather in an inclusive sense of “at least consisting of”. Indications such as “a” and “one” shall not be construed as limited to “only one”, but instead have the meaning of “at least a single one” and do not exclude plurality. Expressions such as: “means for . . . ” should be read as: “component configured for . . . ” or “member constructed to . . . ” and should be construed to additionally include all equivalents of the structures described. The use of expressions such as: “critical”, “advantageous”, “preferably”, “desired”, et cetera, is not intended to limit the invention. Moreover, also features that are not specifically or expressly described or claimed in the construction according to the invention but do fall within the purview of the skilled artisan may be additionally included without departing from the scope of protection as determined by the claims.

1. An apparatus for generating energy from flowing water, the apparatus comprising:
a paddle wheel rotatable around a horizontally disposed shaft, with a plurality of paddles arranged along an outer circumference of the paddle wheel,
channeling means for channeling a water stream in a range of the paddle wheel that is located under the horizontally disposed shaft,
a generator for electric energy, driven by the paddle wheel,
setting means for automatically setting an optimal position taken up by the paddle wheel relative to a water surface of the water stream,
wherein an interaction taking place between the water stream and individual paddles of the plurality of paddles arranged along the outer circumference of the paddle wheel is optimized.

2. The apparatus according to claim 1, wherein the generator driven by the paddle wheel is a permanent magnet generator.

3. The apparatus according to claim 1, wherein the setting means are expanded to include an intelligent data system.

4. The apparatus according to claim 1, wherein the paddle wheel has a core drum, whose centerline coincides with the horizontal shaft and which at each of its opposite axial ends comprises a side flange, which extends radially from an outer circumference of the core drum.

5. The apparatus according to claim 1, wherein the paddle wheel rotatable around the horizontal shaft comprises a plurality of individually movable paddles.

6. The apparatus according to claim 5, wherein each individual paddle is movable between a passive tangential position, in which it can pass in a water stream with minimal resistance, and an active radial position, in which it can be optimally driven by a water stream.

7. The apparatus according to claim 5, wherein each individually movable paddle is pivotable about a paddle pivot which extends parallel to the horizontal shaft.

8. The apparatus according to claim 5, wherein each individually movable paddle is pivotable about a paddle pivot which extends parallel to the horizontal shaft and is situated at the outer circumference of the core drum.

9. The apparatus according to claim 7, wherein each paddle pivot extending parallel to the horizontal shaft comprises a pivot which is arranged between the opposite end flanges.

10. The apparatus according to claim 6, wherein movement of each paddle from the passive tangential position to the active radial position is limited by a stop.

11.-12. (canceled)

13. The apparatus according to claim 1, wherein the automatic setting means are configured for, starting from measurements, through software, giving a command to set the waterwheel at a different height position relative to the water surface.

14. The apparatus according to claim 1, wherein the automatic setting means further comprise at least a communication module and/or a monitoring module, at least one of which is configured for, at low electric tension, limiting the power consumption by partly switching off the automatic setting means.

15. The apparatus according to claim 1, wherein the automatic setting means comprise a monitoring module which is configured for, in a predetermined time interval, activating a PLC unit and a communication module of the automatic setting means to carry out measurements and to process obtained measuring data to optimize, or keep optimal, the position taken up by the paddle wheel relative to the water surface.

16.-17. (canceled)

18. The apparatus according to claim 1, wherein the apparatus is part of a weir with a fall in height between an inlet water surface at an upstream side and an outlet water surface on a downstream side, which weir is arranged for water management of a polder, wherein the channeling means are implemented as a movable water guide at the upstream side, wherein the setting means for optimizing comprise at least a single carrying arm which carries the horizontally disposed shaft and which extends from a fixed pivoting point at the downstream side up to a height adjustable slide, and wherein the at least single arm is movable up and down about the fixed pivoting point together with the horizontally disposed shaft, along with the height-adjustable slide and the movable water guide with the carrying arm.

19.-20. (canceled)

21. The apparatus according to claim 18, further comprising measures for protecting the water population comprising a grid placed at the upstream side.

22.-23. (canceled)

24. The apparatus according to claim 1, wherein the apparatus is part of a hydroelectric plant placed off the fairway in the surface water along the bank of a river, wherein the channeling means are formed by at least a single float, and wherein the setting means for optimizing comprise a ballast tank and a pump which is included in the at least single float and is in fluid communication with the surface water and the ballast tank.

25. The apparatus according to claim 24, wherein the hydroelectric plant is anchored to a river groyne in a manner so as to be movable up and down.

26. (canceled)

27. The apparatus according to claim 24, wherein the horizontally disposed shaft of the paddle wheel is bearing-mounted to the at least single float.

28. The apparatus according to claim 24, wherein the paddle wheel is arranged between the at least single float and a second float.

29.-30. (canceled)

31. The apparatus according to claim 28, wherein the second float also comprises a ballast tank which is part of the setting means.

32.-34. (canceled)
